(19) United States
(12) Patent Application Publication
(10) Pub. No.: US 2023/0194685 A1
(43) Pub. Date: Jun. 22, 2023

(54) ACTIVE/PASSIVE PIXEL CURRENT INJECTION AND BIAS TESTING

(71) Applicant: Allegro MicroSystems, LLC, Manchester, NH (US)

(72) Inventors: Adam Lee, Portland, OR (US); Charles Myers, Portland, OR (US)

(73) Assignee: Allegro MicroSystems, LLC, Manchester, NH (US)

(21) Appl. No.: 17/648,702

(22) Filed: Jan. 24, 2022

Related U.S. Application Data
(60) Provisional application No. 63/290,976, filed on Dec. 17, 2021.

(51) Int. Cl. G01S 7/497; G01S 7/4865; G01S 7/4863; G01S 17/89

(52) U.S. Cl. CPC G01S 7/497; G01S 7/4865; G01S 7/4863; G01S 17/89

(57) ABSTRACT

Systems, methods, and circuits for electrical pixel background current injection tests for lidar systems are described. Systems, methods, and circuits for electrical pixel timing pulse current injection tests for lidar systems are further described. Systems, methods, and circuits for or pixel photodiode health checking/testing using on-chip bias adjustment and passive photo-current imaging circuitry for lidar systems are also described. Embodiments can be used for specification of an Application Safety Integration Level (ASIL) in compliance with a safety standard such as ISO 26262 or the like.

### CROSS-REFERENCE TO RELATED APPLICATION

This application claims priority to and benefit of U.S. Provisional Application No. 63/290,976 filed Dec. 17, 2021 and entitled “Active/Passive Pixel Current Injection and Bias Testing,” the entire content of which is incorporated herein by reference.

### BACKGROUND

As is known in the art, pixel circuits used in photonic detection systems look for active transient signals indicating optical returns from pulse-illuminated scenes of interest. The pulsed illumination propagates from the optical source, reflects off objects in the active imaging system field of view, and returns towards the active imaging system. Pixels in the active imaging system convert this input energy, generally photo-current from a photo-detector device, into a voltage signal that is compared to a threshold for detecting the presence and timing of an active optical return. The timing information from this active system is used to calculate range to an object in the field of view of the active imaging system.

### SUMMARY

An aspect of the present disclosure is directed to and provides for electrical pixel background current injection tests for lidar systems and components that may be used for, e.g., specification of an Application Safety Integration Level (ASIL) in compliance with a safety standard such as ISO 26262 or the like.

A further aspect of the present disclosure is directed to and provides for electrical pixel timing pulse current injection tests for lidar systems and components that may be used for, e.g., specification of an Application Safety Integration Level (ASIL) in compliance with a safety standard such as ISO 26262 or the like.

A further aspect of the present disclosure is directed to and provides for pixel photodiode health checking/testing using on-chip bias adjustment and passive photo-current imaging circuitry for lidar systems and components that may be used for, e.g., specification of an Application Safety Integration Level (ASIL) in compliance with a safety standard such as ISO 26262 or the like.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a block diagram showing major components of an example embodiment of a lidar system, in accordance with the present disclosure;

FIG. 2 is a block diagram of a system/circuit for electrical pixel background current injection tests for lidar systems and components, in accordance with example embodiments of the present disclosure;

FIG. 3 is a block diagram of a system/circuit for electrical pixel timing pulse current injection tests for lidar systems and components, in accordance with example embodiments of the present disclosure;

FIG. 4 is a block diagram of a system/circuit for pixel photodiode health checking/testing using on-chip bias adjustment and passive photo-current imaging circuitry, in accordance with example embodiments of the present disclosure; and

FIG. 5 is a block diagram of an example computer system operative to perform processing, in accordance with the present disclosure.

### DETAILED DESCRIPTION

Prior to describing example embodiments of the present disclosure some information is provided. Laser ranging systems can include laser radar (ladar), light-detection and ranging (lidar), and range-finding systems, which are generic terms for the same class of instrument that uses light to measure the distance to objects in a scene. This concept is similar to radar, except optical signals are used instead of radio waves. Similar to radar, a laser ranging and imaging system emits a pulse toward a particular location and measures the return echoes (reflections) to extract the range.

Laser ranging systems generally work by emitting a laser pulse and recording the time it takes for the laser pulse to travel to a target, reflect, and return to a photoreceiver, which time is commonly referred to as the “time of flight.” The laser ranging instrument records the time of the outgoing pulse—either from a trigger or from calculations that use measurements of the scatter from the outgoing laser light—and then records the time that a laser pulse returns. The difference between these two times is the time of flight to and from the target. Using the speed of light, the round-trip time of the pulses is used to calculate the distance to the target.

Lidar systems may scan the beam (or, successive pulses) across a target area to measure the distance to multiple points across the field of view, producing a full three-dimensional range profile of the surroundings. More advanced flash lidar cameras, for example, contain an array of detector elements, each able to record the time of flight to objects in their field of view.

When using light pulses to create images, the emitted pulse may intercept multiple objects, at different orientations, as the pulse traverses a 3D volume of space. The reflected (or echoed) laser-pulse waveform contains a temporal and amplitude imprint of the scene. By sampling the light reflections or echoes, a record of the interactions of the emitted pulse is extracted with the intercepted objects of the scene, allowing an accurate multi-dimensional image to be created. To simplify signal processing and reduce data storage, laser ranging and imaging can be dedicated to discrete-return systems, which record only the time of flight (TOF) of the first, or a few, individual target returns to obtain angle-angle-range images. In a discrete-return system, each recorded return corresponds, in principle, to an individual laser reflection (i.e., an echo from one particular reflecting surface, for example, a tree, pole or building). By recording just a few individual ranges, discrete-return systems simplify signal processing and reduce data storage, but they do so at the expense of lost target and scene reflectivity data. Because laser-pulse energy has significant associated costs and drives system size and weight, recording the TOF and pulse amplitude of more than one laser pulse return per transmitted pulse, to obtain angle-angle-range-intensity images, increases the amount of captured information per unit of pulse energy. All other things equal, capturing the full pulse return waveform offers significant advantages, such that the maximum data is extracted from the investment in average laser power. In full-waveform systems, each backscattered laser pulse received by the system is digitized at a high sampling rate (e.g., 500 MHz to 1.5 GHz). This process generates digitized waveforms (amplitude versus time) that may be processed to achieve higher-fidelity 3D images.

Of the various laser ranging instruments available, those with single-element photoreceivers generally obtain range data along a single range vector, at a fixed pointing angle. This type of instrument—which is, for example, commonly used by golfers and hunters—either obtains the range (R) to one or more targets along a single pointing angle or obtains the range and reflected pulse intensity (I) of one or more objects along a single pointing angle, resulting in the collection of pulse range-intensity data, (R,I)ᵢ, where i indicates the number of pulse returns captured for each outgoing laser pulse.

More generally, laser ranging instruments can collect ranging data over a portion of the solid angles of a sphere, defined by two angular coordinates (e.g., azimuth and elevation), which can be calibrated to three-dimensional (3D) rectilinear cartesian coordinate grids; these systems are generally referred to as 3D lidar and ladar instruments. The terms “lidar” and “ladar” are often used synonymously and, for the purposes of this discussion, the terms “3D lidar,” “scanned lidar,” or “lidar” are used to refer to these systems without loss of generality. 3D lidar instruments obtain three-dimensional (e.g., angle, angle, range) data sets. Conceptually, this would be equivalent to using a rangefinder and scanning it across a scene, capturing the range of objects in the scene to create a multi-dimensional image. When only the range is captured from the laser pulse returns (reflections), these instruments obtain a 3D data set (e.g., angle, angle, range)ₙ, where the index n is used to indicate that a series of range-resolved laser pulse returns can be collected, not just the first reflection.

Some 3D lidar instruments are also capable of collecting the intensity of the reflected pulse returns generated by the objects located at the resolved (angle, angle, range) objects in the scene. When both the range and intensity are recorded, a multi-dimensional data set (e.g., angle, angle, (range-intensity)ₙ) is obtained. This is analogous to a video camera in which, for each instantaneous field of view (FOV), each effective camera pixel captures both the color and intensity of the scene observed through the lens. However, 3D lidar systems, instead capture the range to the object and the reflected pulse intensity.

Lidar systems can include different types of lasers operating at different wavelengths, including those that are not visible (e.g., wavelengths of 840 nm or 905 nm), in the near-infrared (e.g., at wavelengths of 1064 nm or 1550 nm), and in the thermal infrared including wavelengths known as the “eye-safe” spectral region (generally those beyond 1300-nm), where ocular damage is less likely to occur. Lidar transmitters produce emissions (laser outputs) that are generally invisible to the human eye. However, when the wavelength of the laser is close to the range of sensitivity of the human eye—the “visible” spectrum, or roughly 350 nm to 730 nm—the energy of the laser pulse and/or the average power of the laser must be lowered to avoid causing ocular damage. Certain industry standards and/or government regulations define “eye safe” energy density or power levels for laser emissions, including those at which lidar systems typically operate. For example, industry-standard safety regulations IEC 60825-1: 2014 and/or ANSI Z136.1-2014 define maximum power levels for laser emissions to be considered “eye safe” under all conditions of normal operation (i.e., “Class 1”), including for different lidar wavelengths of operation. The power limits for eye safe use vary according to wavelength due to absorption characteristics of the structure of the human eye. For example, because the aqueous humor and lens of the human eye readily absorb energy at 1550 nm, little energy reaches the retina at that wavelength. Comparatively little energy is absorbed, however, by the aqueous humor and lens at 840 nm or 905 nm, meaning that most incident energy at that wavelength reaches and can damage the retina. Thus, a laser operating at, for example, 1550 nm, can—without causing ocular damage—generally have 200 times to 1 million times more laser pulse energy than a laser operating at 840 nm or 905 nm.

One challenge for a lidar system is detecting poorly reflective objects at long distance, which requires transmitting a laser pulse with enough energy that the return signal—reflected from the distant target—is of sufficient magnitude to be detected. To determine the minimum required laser transmission power, several factors should be considered. For instance, the magnitude of the pulse returns scattering from the diffuse objects in a scene is proportional to their range and the intensity of the return pulses generally scales with distance according to 1/R\hat{ }4 for small objects and 1/R\hat{ }2 for larger objects; yet, for highly-specula rly reflecting objects (i.e., those objects that are not diffusively-scattering objects), the collimated laser beams can be directly reflected back, largely unattenuated. This means that—if the laser pulse is transmitted, then reflected from a target 1 meter away—it is possible that the full energy (J) from the laser pulse will be reflected into the photoreceiver; but—if the laser pulse is transmitted, then reflected from a target 333 meters away—it is possible that the return will have a pulse with energy approximately 10\hat{ }12 weaker than the transmitted energy. To provide an indication of the magnitude of this scale, the 12 orders of magnitude (10\hat{ }12) is roughly the equivalent of: the number of inches from the earth to the sun, 10×the number of seconds that have elapsed since Cleopatra was born, or the ratio of the luminous output from a phosphorescent watch dial, one hour in the dark, to the luminous output of the solar disk at noon.

In many cases of lidar systems highly sensitive photoreceivers are used to increase the system sensitivity to reduce the amount of laser pulse energy that is needed to reach poorly reflective targets at the longest distances required, and to maintain eye-safe operation. Some variants of these detectors include those that incorporate photodiodes, and/or offer gain, such as avalanche photodiodes (APDs) or single-photon avalanche detectors (SPADs). These variants can be configured as single-element detectors,-segmented-detectors, linear detector arrays, or area detector arrays. Using highly sensitive detectors such as APDs or SPADs reduces the amount of laser pulse energy required for long-distance ranging to poorly reflective targets. A technological challenge of these photodetectors is that they should also be able to accommodate the incredibly large dynamic range of signal amplitudes.

As dictated by the properties of the optics, the focus of a laser return changes as a function of range; as a result, near objects are often out of focus. Furthermore, also as dictated by the properties of the optics, the location and size of the “blur”—i.e., the spatial extent of the optical signal—changes as a function of range, much like in a standard camera. These challenges are commonly addressed by using large detectors, segmented detectors, or multi-element detectors to capture all of the light or just a portion of the light over the full-distance range of objects. It is generally advisable to design the optics such that reflections from close objects are blurred, so that a portion of the optical energy does not reach the detector or is spread between multiple detectors. This design strategy reduces the dynamic range requirements of the detector and prevents the detector from damage.

Acquisition of the lidar imagery can include, for example, a 3D lidar system embedded in the front of car, where the 3D lidar system, includes a laser transmitter with any necessary optics, a single-element photoreceiver with any necessary dedicated or shared optics, and an optical scanner used to scan (“paint”) the laser over the scene. Generating a full-frame 3D lidar range image—where the field of view is 20 degrees by 60 degrees and the angular resolution is 0.1 degrees (10 samples per degree)—can require emitting 120,000 pulses (20*10*60*10=120,000). When update rates of 30 frames per second are required, such as is commonly required for automotive lidar, roughly 3.6 million pulses per second must be generated and their returns captured.

There are many ways to combine and configure the elements of the lidar system—including considerations for the laser pulse energy, beam divergence, detector array size and array format (e.g., single element, linear (1D) array, or 2D array), and scanner to obtain a 3D image. If higher power lasers are deployed, pixelated detector arrays can be used, in which case the divergence of the laser would be mapped to a wider field of view relative to that of the detector array, and the laser pulse energy would need to be increased to match the proportionally larger field of view. For example—compared to the 3D lidar above—to obtain same-resolution 3D lidar images 30 times per second, a 120,000-element detector array (e.g., 200×600 elements) could be used with a laser that has pulse energy that is 120,000 times greater. The advantage of this “flash lidar” system is that it does not require an optical scanner; the disadvantages are that the larger laser results in a larger, heavier system that consumes more power, and that it is possible that the required higher pulse energy of the laser will be capable of causing ocular damage. The maximum average laser power and maximum pulse energy are limited by the requirement for the system to be eye-safe.

As noted above, while many lidar system operate by recording only the laser time of flight and using that data to obtain the distance to the first target return (closest) target, some lidar systems are capable of capturing both the range and intensity of one or multiple target returns created from each laser pulse. For example, for a lidar system that is capable of recording multiple laser pulse returns, the system can detect and record the range and intensity of multiple returns from a single transmitted pulse. In such a multi-pulse lidar system, the range and intensity of a return pulse from a from a closer-by object can be recorded, as well as the range and intensity of later reflection(s) of that pulse—one(s) that moved past the closer-by object and later reflected off of more-distant object(s). Similarly, if glint from the sun reflecting from dust in the air or another laser pulse is detected and mistakenly recorded, a multi-pulse lidar system allows for the return from the actual targets in the field of view to still be obtained.

The amplitude of the pulse return is primarily dependent on the specular and diffuse reflectivity of the target, the size of the target, and the orientation of the target. Laser returns from close, highly-reflective objects, are many orders of magnitude greater in intensity than the intensity of returns from distant targets. Many lidar systems require highly sensitive photodetectors, for example avalanche photodiodes (APDs), which along with their CMOS amplification circuits. So that distant and poorly-reflective targets may be detected, the photoreceiver components may be optimized for high conversion gain. Largely because of their high sensitivity, these detectors may be damaged by very intense laser pulse returns.

For example, if an automotive equipped with a front-end lidar system were to pull up behind another car at a stoplight, the reflection off of the license plate may be significant—perhaps 10\hat{ }12 higher than the pulse returns from targets at the distance limits of the lidar system. When a bright laser pulse is incident on the photoreceiver, the large current flow through the photodetector can damage the detector, or the large currents from the photodetector can cause the voltage to exceed the rated limits of the CMOS electronic amplification circuits, causing damage. For this reason, it is generally advisable to design the optics such that the reflections from close objects are blurred, so that a portion of the optical energy does not reach the detector or is spread between multiple detectors. However, capturing the intensity of pulses over a larger dynamic range associated with laser ranging may be challenging because the signals are too large to capture directly. One can infer the intensity by using a recording of a bit-modulated output obtained using serial-bit encoding obtained from one or more voltage threshold levels. This technique is often referred to as time-over-threshold (TOT) recording or, when multiple-thresholds are used, multiple time-over-threshold (MTOT) recording.

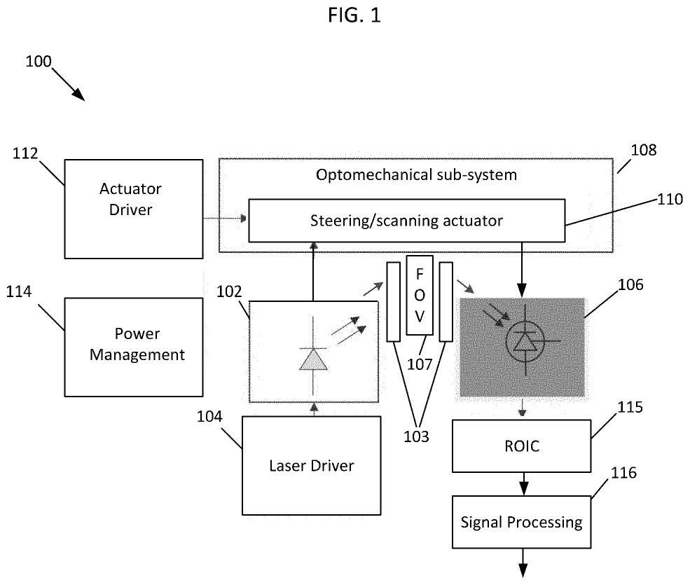

FIG. 1 is a block diagram showing major components of an example embodiment of a lidar system 100, in accordance with the present disclosure. System 100 can be a scanned lidar system in some embodiments, a flash lidar system in other embodiments, or a hybrid (scanning/flash) system in still other embodiments. System 100 includes an illumination source 102, shown as laser diode, connected to laser driver 104. Optics 103 are shown and can be used for the illumination source 102 and/or receiver 106 (e.g., in monostatic or bistatic configurations). The illumination source (e.g., a laser or LED) 102 produces an output (e.g., one or more laser pulses). Appropriate pumping energy may be supplied by suitable sources, e.g., diodes lasers, for the case where laser 102 includes a non-semiconductor active medium. An optical receiver (e.g., detector) 106, shown as a representative photodiode, receives laser returns (reflections of the laser outputs) from objects and/or surfaces in the FOV 107. The detector 106 can include an array of induvial detectors, e.g., a one-dimensional array (1×N) or a two-dimensional array (M×N). Field of view (FOV) 107 of the detector is shown on the optical path between the laser (illumination source) 102 and the detector 106, which is directed to and “viewing” the FOV 107. Detector 106 operates to detect energy reflected from objects and/or surfaces in the FOV 107. An optomechanical subsystem 108, e.g., including a steering/scanning actuator 110 for transmit beam steering, can be included and operate to scan the illumination source 102 and receiver 106. An actuator driver 112 can control the movement of the actuator 110. While embodiments of system 100 can be configured as scanning lidar systems, other embodiments of system 100 can be configured as flash lidar systems not utilizing steering/scanning such that optomechanical subsystem 108 or subcomponents 110 and/or 112 may be omitted.

System 100 further includes a power management block 114, which provides and controls power to the system 100. Once received at the receiver 106, the incident photons are converted by the receiver 106 (e.g., photodiodes) to electrical signals, which can be read-out by for signal processing. A readout integrated circuit or circuitry (ROIC) 115 is shown connected to receiver (detector) 106 for receiving the output from the receiver 106. ROIC 115 can be used for, e.g., amplification, discrimination, timing, and digitization. The term ROIC as used herein can include reference to a digital ROIC (DROIC) or a digital pixel ROIC (DPROIC) and embodiments of ROIC 115 can include or be configured as, e.g., a DROIC or a DPROIC. Signal processing block 116 is shown as receiving an output from ROIC 115, and may be used for further signal processing of the signals generated from the returns, e.g., point cloud generation, etc.

Implementation of lidar systems (e.g., similar to system 100) in automotive or other safety-sensitive applications can require meeting a safety standard such as ISO 26262, which includes specification of an Application Safety Integration Level (ASIL). In order to meet the high fault detectability standards required, methods for detecting safety-critical faults and reporting them to a fault handling system may be required. The faults may either be located within the lidar system or in systems relied-upon by the lidar system. Tests for such faults can facilitate meeting ASIL or other safety requirements.

An aspect of the present disclosure is directed to and provides for electrical pixel background current injection tests for lidar systems and components that may be used for, e.g., specification of an Application Safety Integration Level (ASIL) in compliance with a safety standard such as ISO 26262 or the like.

Many of the active pixel detection systems used in lidar systems require a method for managing background current and dark current coming from the photo detector in normal operation. Active pixel circuits detect changes in input current level, ignoring static background current arising from background illumination and photo detector device leakage current (dark current). These circuits use various methods for removing or ignoring the background and dark current—if these systems fail, active data will become corrupted and may result in an unsafe condition in the lidar system.

In addition to background and dark current removal, lidar systems may also utilize measurements of the background and dark current for tasks such as modification of optical illumination power, sensitivity settings, or many other configuration modifications. Being able to trust these measurements is critical for the safe operation of the lidar system.

In-situ testing of active pixel background measurement or correction features is not possible when the photo detector is directly connected to the pixel. The photo detector may be producing background and dark current that is not knowable by the test system and therefore the difference between correct and incorrect operation is not discernable. Instead, utilizing a replica active pixel with no connection to a photo-detector and test current injection method allows checking for correct operation of both the background and dark current measurement and correction features without interference from other devices.

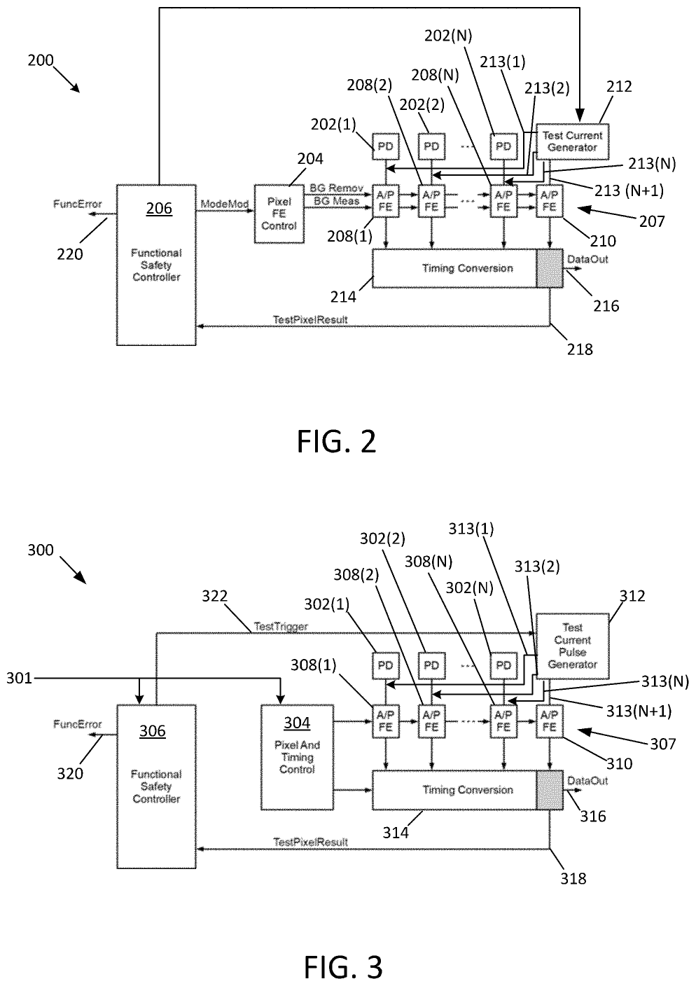

FIG. 2 is a block diagram of system/circuit 200 for electrical pixel background current injection tests for lidar systems and components, in accordance with example embodiments of the present disclosure. The system/circuit 200 includes one or multiple arrayed photo-detectors (e.g., photo-diodes) 202(1)-(N) and active/passive pixel front-end circuitry 207 including a number (or plurality) of pixel active/passive (A/P) font end circuits 208(1)-(N), which are configured to receive outputs from the photo-detectors 202(1)-(N). System/circuit 200 further includes a test current generator 212 that is configured to produce one or more static (constant or non-time varying) test currents and provide the test current(s) to one or more of the (A/P) font end circuits 208(1)-(N) and/or a test A/P front end circuit 210, as described in further detail below. System/circuit 200 also includes a pixel front end control circuit 204, a timing conversion circuit 214, and a functional safety controller 206.

Each photo-detector (e.g., photo-diode) 202 produces current proportional to the number of photons striking the device per unit of time. The photo-current produced can be due to passive background illumination or active transient illumination or a combination of both active and passive illumination. In the case of an active illumination application such as lidar, the passive background current is an unwanted signal and should be measured and removed. The photo-detector current, containing both active and passive background components, is delivered to the pixel active/passive front-end circuitry 207—including A/P FE circuits 208(1)-(N).

Each pixel active/passive front-end (A/P FE) circuit 208 takes the photo-detector photo-current, received from the respectively connected photo-detector, as an input and produces a digital output that is representative of the arrival time of an active, transient photo input to the photo-detector. The front-end circuit 208 also samples and stores the background current and uses the sample to cancel the background current and make the front-end circuit more sensitive to active input signals. The front-end circuit 208 also can be configured in a mode where the passive background photo-current is measured and is converted to a timing signal proportional to the background current level. The configuration and timing governing these operations is managed by a shared pixel front-end controller 204.

In operation, the test current generator 212 produces a static current output 213. In some embodiments, the static output current 213 can be provided to a single active/passive pixel front-end circuit 210, which may be a test (or “dummy”) A/P FE circuit. In other embodiments and/or under other conditions, additional static output currents 213(1)-(N) can be provided to one or a group (plurality) of the A/P FE circuits 208(1)-(N), e.g., one or more and up to all of the A/P FE circuits 208(N). In some embodiments, the test current generator generates 212 a fixed current that is similar in magnitude to expected scene background levels. In other embodiments, the test current generator 212 is programmable to produce a range of static test currents.

The pixel front-end controller 204 develops control signals and references for configuring and operating the active/passive pixel front-end circuitry 207. This controller 204 is responsible for configuring and operating the pixel front-end in such a way as to cause each individual pixel front-end circuit 208(1)-(N) and 210 to measure and store background signal information and remove the background, passive photo-current signal from the active photo-current signal. The controller is also responsible for configuring the pixel front-end circuits 208(1)-(N) and 210 to measure the background photo-current and produce timing outputs proportional to the background, passive photo-current level.

The timing conversion circuit 214 evaluates the pixel front-end output signals with respect to a timing reference and produces digital timing codes representing the time of arrival of the active photo-current returns or a digital timing code that is proportional to the passive photo-current level observed by the respective active/passive pixel front-end circuits 208(1)-(N) and 210. The bulk of the data is read-out to support application operation, as shown at 216. In some embodiments, however the data (shown at 218) from the test pixel front-end circuit 210 attached to the test current generator 212 is passed to the functional safety controller 206.

The functional safety controller 206 can command the operation of various pixel front-end configurations including background signal removal or background measurement and read-out. The functional safety controller 206 can be connected to test current generator 212, as shown. The controller 206 also can command enabling or modifying test current generation from the test current generator 212. The controller 206 evaluates the output of the data associated with the test current generator 212 and coupled active/passive pixel front-end circuit 208(1)-(N) and/or 210 and compares the result(s) with expected results. If the value(s) is/are in an expected range, then the pixel front-end controller 206 is functioning properly as is/are the pixel front-end circuits (208(1)-(N) and/or 210) coupled to the test current generator 212. However, if the background removal operation or the background measurement operation becomes faulty, for whatever reason, the data evaluated by the functional safety controller 206 will be outside of the expected operation range and the functional safety controller 206 will report the functional safety error to the application system, as shown by 220.

In one embodiment, the functional safety controller 206 reports only that an exceedance of the expected passive signal measurement or passive signal removal operation occurred. In another embodiment, the functional safety controller 206 reports the extent of the exceedance of the passive signal measurement or passive signal removal operation. Embodiments of system/circuit 200, e.g., not including detectors 202(1)-(N), can be configured as part of or in a readout integrated circuit (ROIC).

A further aspect of the present disclosure is directed to and provides for electrical pixel timing pulse current injection testing/tests for lidar systems and components that may be used for, e.g., specification of an Application Safety Integration Level (ASIL) in compliance with a safety standard such as ISO 26262 or the like.

Lidar applications requiring the meeting of safety standards such as ISO 26262 can require components of the lidar system to be able to identify faults in their operation or data with defined fault detection coverage levels known as ASIL, as previously noted. Meeting these requirements means that lidar systems need to be aware of any component failures that may produce a safety hazard in the lidar application. Lidar sensors have many sub-systems that must be functional in order to produce reliable ranging data. This includes biasing and control signals for managing analog and digital component circuitry and faults in these operations may cause incorrect range information to be produced by the sensor or lidar system resulting in a safety hazard.

One prior solution to identifying the health of these component systems is to make multiple parallel systems and compare outputs to verify correct operation. This can require a high design cost and may be physically impossible to implement in arrayed systems. Another prior method is to design additional “checker” circuits that evaluate the status of all the inputs and make sure they are within set limits of operation. This, too, can require a significant amount of additional circuitry and can lead to high complexity and the possibility of “false positive” checker results that may entirely miss the development of a fault condition in the lidar sensor.

In contrast with the above-mentioned prior techniques, embodiments of the present disclosure can utilize bias and control systems for controlling a test channel identical to the sensor channel and to drive the input of this test channel with a controllable and known input. If the observed result is correct, the bias and control systems are verified as not producing faults that would lead to incorrect ranging information. Further, this system can periodically adjust the test input to validate the full range of possible inputs simultaneously validating the operational range of the sensor and verifying that the operation is continuously updating and not stuck at any single range measurement.

FIG. 3 is a block diagram of system/circuit 300 for electrical pixel timing pulse current injection tests for lidar systems and components, in accordance with example embodiments of the present disclosure. System/circuit 300 can include one or multiple arrayed photo-detectors 302(1)-(N) and active/passive pixel front-end circuitry 307 including a number (plurality) of active/passive pixel front-end (A/P FE) circuits 308(1)-(N), which are configured to receive outputs from the photo-detectors 302(1)-(N). System/circuit 300 can also include a test current pulse generator 312 that is configured to produce one or more pulsed (e.g., transient or time-varying) test currents and provide the test current(s) to one or more of the (A/P) font end circuits 308(1)-(N) and/or a test A/P front end circuit 310, as described in further detail below. A pixel and timing control circuit (controller) 304, a timing conversion circuit 314, and a functional safety controller 306 can also be included, as shown.

As noted previously, a photo-detector 302 is a device that produces current proportional to the number of photons striking the device per unit of time. In lidar operation, an optical “return” would be seen as a transient current pulse at the output of the photo-detector. The photo-detectors 302 (1)-(N) connect to the pixel front-end circuitry 307 and deliver the photo-current to the A/P FE circuits 308(1)-(N).

A pixel active/passive front-end circuit (A/P FE) 308 takes the photo-detector photo-current, received from the respective connected photo-detector 302, as an input and produces a digital output that is representative of the arrival time of an active, transient photo input to the photo-detector 302. Configuration, bias, and timing controls are provided by a global controller—shown as pixel and timing controller 304—to manage operations of the pixel front-end circuitry 307, including the A/P FE circuits 308(1)-(N).

In operation, the test current pulse generator 312 produces a pulsed current output 313, e.g., that approximates the duration and amplitude of a typical optical return converted to a current pulse by the photo-detectors. In some embodiments, the pulsed output current 313 can be provided to a single active/passive pixel front-end circuit 310, which may be a test (or “dummy”) A/P FE circuit. In other embodiments and/or under other conditions, a pulsed output current 313(1)-(N) can be provided to one or a group (plurality) of the A/P FE circuits 308(1)-(N), e.g., one or more and up to all of the A/P FE circuits 308(N). In one embodiment, the pulse width and amplitude of the pulsed output current 313 are fixed. In other embodiments, the pulse width and/or pulse amplitude of the pulsed output current 313 may be selectively adjustable, e.g., by programming the test current pulse generator 312 and/or functional safety controller 306. The functional safety controller 306 can produce an output that functions as a timing input, indicated as “Test Trigger” 322, for the test current pulse generator 312 to signal the test current pulse generator 312 when to produce the pulsed output 313. The Test Trigger 322 may be provided notionally at any time.

The pixel and timing controller 304 develops control signals, biases, and references for configuring and operating the pixel front-end circuitry 307. The timing functions of the controller 304 operate relative to a provided timing reference 301 (for synchronization of test current generator 312 to normal operational timing of the lidar system). The controller 304 also develops biases and control signals for managing the timing conversion circuit 314.

The timing conversion circuit 314 evaluates the pixel output signals with respect to a timing reference and produces digital timing codes representing the time of arrival of the active photo-current returns. The bulk of the data 316 is read-out to support application operation. In some embodiments, however, the data (shown as 318) from the test active/passive (A/P) pixel front-end circuit 310 (attached to the test current pulse generator 312) is passed to the functional safety controller 306.

The functional safety controller 306 provides a test pulse trigger 322 (shown as “TestTrigger”) input to the test current pulse generator 312 and controls when this occurs with respect to other timing operations using a provided timing reference 301. Because of this, the functional safety controller 306 knows the timing code that should be produced by any commanded test pulse trigger signal. In one embodiment, a single input pulse is generated periodically, and the test output is evaluated to confirm that the expected timing code is produced. In another embodiment, the functional safety controller 306 utilizes, e.g., a counter, or some other delay means to shift the location in time of the pulse trigger input to provide a varying timing test that can cover a larger timing input range and verify that the timing results are updating with each return acquisition operation.

The functional safety controller 306 compares the output from the test data path to the expected output and sets a fault flag, shown as 320, if the result is not within an acceptable band around the expected value. This fault flag 320 is provided to the application system (not shown), e.g., a lidar control system, which can use the fault information to determine an appropriate system behavior for avoiding a safety hazard. Embodiments of system/circuit 300, e.g., without detectors 302(1)-(N), can be configured as a readout integrated circuit (ROIC).

In alternate embodiments (e.g., receiver embodiments), each of the A/P FE circuits 308(1)-(N) can be implemented with or configured to produce an analog output, and the timing conversion block 314 can include or be implemented to contain a digitizer and digital signal processor operative for waveform sampling. In this configuration, each A/P FE 308 can create a continuous output voltage that is representative of the input DC and transient photocurrent from the connected photodiode element 302, respectively. This output voltage can then be digitized within the timing conversion block 314, for example, using an analog-to-digital converter (ADC) (not shown) having a sufficiently high clock speed, e.g., in the GHz or multiple GHz range. Subsequent signal processing of the digitized waveforms can be used to extract pulse timing information as well as static current of the photodiode elements 302(1)-(N). This extracted timing and static information can then passed to the functional safety controller 306 where it can be used to determine fault states within the receiver, e.g., including system/circuit 300.

A further aspect of the present disclosure is directed to and provides for pixel photodiode health checking or testing, using on-chip bias adjustment and passive photo-current imaging circuitry that may be used for, e.g., specification of an Application Safety Integration Level (ASIL) in compliance with a safety standard such as ISO 26262 or the like.

Lidar imaging systems rely on photo-detector elements to convert optical photon energy into photo-current and active detection circuitry to sense these signals and perform precise measurements of the return signals for determining range or other lidar scene characteristics. The photo-detectors are often arranged in arrays for detecting simultaneous returns in a pixelated field of view.

In the context of a system using lidar data for safety-critical applications, such as autonomous driving, it can be critical to be aware of the functional state of the photo detectors. Since photo-detectors produce current due to constant background photo stimulus (e.g., from ambient light or heat) and/or even produce leakage current with no photo stimulus (dark current), a measurement detecting background or dark current can be used as a status check of the photo-detector if there are no other sources of current present at the detector node. Additional circuits that can produce leakage currents may be connected to the photo detector for detection of signals from the photo-detector, so it may not be possible to isolate the current sources in a test by just measuring the static current.

Embodiments of the present disclosure can provide systems, circuits and/or components with control of the photo-diode biases and the ability measure static current can therefore modulate the photo-detector bias and observe changes in photo current to infer correct operation of the photo-detectors. For diode-based photo-detectors, the leakage and background currents can have dependence on voltage bias applied to the photo-diode. If a number of photo-detectors are determined to be non-functional using this test method, the lidar system can report the fault to the control system and appropriate safety responses can be taken.

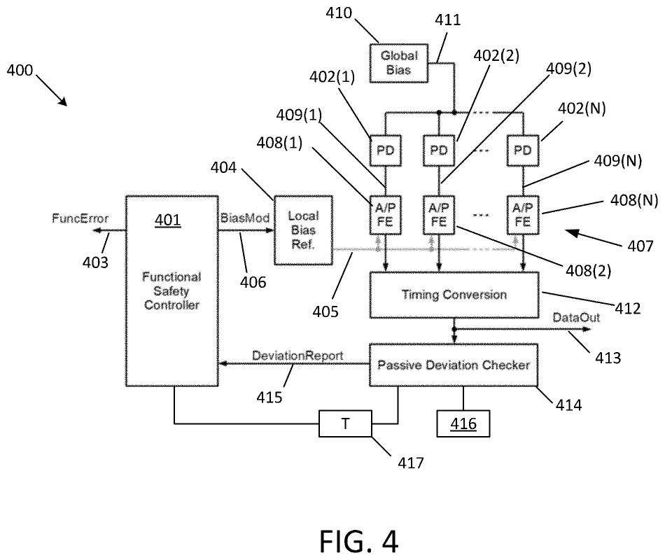

FIG. 4 is a block diagram of system/circuit 400 for pixel photodiode health checking/testing using on-chip bias adjustment and passive photo-current imaging circuitry, in accordance with example embodiments of the present disclosure. System/circuit 400 includes an array of photo-diodes (photo-detectors) 402(1)-(N) and active/passive front-end circuitry 407 including an array of active/passive front-end (A/P FE) pixel circuits 408(1)-(N), which are configured to receive outputs from the photo-diodes 402(1)-(N). System/circuit 400 also includes a local bias reference circuit 404 and a global bias generation circuit 410 that are configured to provide local and global bias voltages to the photo-diodes 402(1)-(N), respectively, as described in further detail below. System/circuit 400 can also include a timing conversion circuit 412, a passive deviation checker circuit 414, and a functional safety controller 401, as shown.

As noted above, photo-diode array 402(1)-(N) is made up of multiple individual photo-diodes (PD), e.g., 402(1), 402(2), etc. When the photo-diodes 402(1)-(N) are properly biased, photons striking each photo-diode (PD) device produces photo-current flowing between the two terminals of the device. The photo-current is proportional to the amount of light striking the photo-diode, and in the case of an avalanche photo-diode, the photo-current is also proportional to the reverse-bias voltage applied to the avalanche photo-diode. A photo-diode also produces current with no incident light—this is known as dark current. The photo-diodes 402(1)-(N) are coupled to individual active/passive front-end pixel (A/P FE) circuits 408(1)-(N) and, as noted, are biased with a combination of a global shared biased and individual biases delivered though the active/passive front-end circuitry 407.

The global bias generation circuit 410 provides a global bias 411, which is one of the two bias voltages used to bias each of the photo-diodes 402(1)-(N). The global bias generation circuit 410 may include a parallel bypass capacitor to reduce the noise on the bias. Generally, the global bias 411 responds slowly to a change in the bias configuration due to the large capacitances on the shared photo-diode connection node.

The active/passive pixel front-end circuits 408(1)-(N) convert photo-current from the photo-diode 402(1)-(N) into useful passive or active signals. For active operation, each pixel front-end circuit, e.g., 408(1), converts photo-diode current pulses received from the connected photo-diode, e.g., 402(1), into full-logic-level voltage pulses which can be timed by subsequent circuits/circuitry to determine the time of arrival of the photo-current pulses. For passive operation, each pixel front-end circuit, e.g., 408(1), converts static photo-current into a digital signal with a pulse edge or pulse width proportional to the static photo-current. The subsequent timing circuits capture the timing relationships of these edges and determine relative static photo-current observed by the pixel front-end. Changes in the photo-current due to varied photo-diode bias or illumination levels are easily detected with the system 400.

The pixel front-end circuitry 407 (including local bias reference circuit 404) also provides second, or local, photo-diode (PD) terminal bias voltages 409(1)-(N) to the photo-diodes 402(1)-(N), respectively. This local bias 409(1)-(N) is delivered to the photo-diodes 402(1)-(N) individually by each connected pixel front-end circuit 408(1)-(N) and may either be identical for every pixel or programmed individually as desired. The combination of the first (global) 411 and second (local) 409 PD terminal bias voltages applied to each photo-diode 402(1)-(N) determines the differential bias voltage for the photo-diode 402(1)-(N), which defines the PD operational bias condition.

The local bias reference circuit 404 provides an analog reference voltage or current or a set of voltages or currents (collectively 405) which are used by the pixel front-end circuits 408(1)-(N) to develop the second or local PD terminal bias 409(1)-(N). This bias reference 405 can be adjustable, e.g., with electrically programmed registers, and can be modified periodically while the pixel front-end circuits 408(1)-(N) are configured for passive photo-current detection. In example embodiments, multiple, e.g., two, different photo-diode bias values can be tested by modulation of the local bias reference voltages or currents.

The timing conversion circuit 412 compares the resulting outputs of the active/passive front-end circuits 408(1)-(N) to a timing reference and determines relative time between front-end outputs and the timing reference. For passive operation, the timing information is proportional to the amount of photo-current generated by the photo-diodes 402(1)-(N).

The passive deviation checker 414 evaluates the difference in passive timing measurements between two or more different local bias reference settings. These comparisons can either be checked against a threshold internally, or the minimum and/or maximum deviations can be sent to the functional safety controller 401. The passive deviation checker 414 can function to evaluate whether photo-diodes 402(1)-(N) are responding as expected to varying bias levels.

A change in the overall bias of a photo-diode produces a change in the current produced by the photo-diode at a given illumination level, or even with no illumination. The passive photo-current is measured with the two different photo-diode biases applied, in example embodiments. An observed change in the photo-current with bias modification indicates a correctly connected and functioning photo-diode. This check may be commanded periodically by a controller, e.g., functional safety controller 401, and the results can be checked by circuitry evaluating the resulting timing information collected from the passive mode operation.

The functional safety controller 401 configures the photo-bias modulation and observes the result of the passive deviation checker 414. Errors can be reported for system-level safety management systems to safely respond to the identified failure of photo-diodes depending on the application and mode of operation.

In one embodiment, the passive deviation checker 414 only computes the minimum and maximum passive measurement for all photo-diode passive measurements and the functional safety controller 401 indicates that at least one photo-diode has failed. In another embodiment, the passive deviation checker 414 computes the individual photo-diode deviations for each tested bias condition and reports a count of all failed pixels to the functional safety controller 401. The functional safety controller 401 may pass this information to a connected application system (not shown), e.g., a lidar control and operation system for automotive applications, to make more nuanced safety decisions based on the number of failed photo-diodes. In another embodiment, the passive deviation checker 414 computes the individual photo-diode deviations for each tested bias conditions and reports a logical address for failed photo-diodes to the functional safety controller 401. The functional safety controller 401 may pass the pixel address to the application system, which may enact various masking or interpolation features to handle failed photo-diodes as acceptable for the safety of the application.

In another embodiment, the functions of the passive deviation checker 414 and functional safety controller 401 can be removed from the lidar system and instead implemented by the application system. In this case, the application system can command the bias modifications and examine the output data to ensure expected behavior of all photo-diodes. Embodiments of system/circuit 400, e.g., without photo-diodes 402(1)-(N), can be included in or configured as a readout integrated circuit (ROIC).

It may be desirable to control the field of view of the photo-detectors during testing to limit or impart a more static and uniform background level. One example may be to only conduct the test when an optical/mechanical system has set the photo-detector field of view to an unchanging portion of the field-of-view such as the sky or ground depending on physical configuration. Another option may be to allow steering of the photo-detector field of view to an optically inactive location (such as interior mechanical housing) to limit all optical sources. Sufficiently quick successive tests in the same field of view may also be sufficient for determining photo-detector operation and connection depending on the application.

Other example embodiments of system 400 can include or implement a calibration of the static photo-detector current at a known background illumination configuration and/or temperature and perform a comparison or comparisons to expected levels during operation. The calibration may be accomplished as a factory or field calibration with a controlled or measured illumination and/or temperature. Measured illumination and/or temperatures may be stored, e.g., in non-volatile memory 416. Static photo-detector level measurements at calibration may also be stored in non-volatile memory 416. The non-volatile memory 416 may be included in or part of the passive deviation checker 414, in some embodiments. In other embodiments, the non-volatile memory may instead or in addition be located outside of the passive deviation checker 414. Temperature information may be delivered from a temperature sensor 417. The temperature sensor 417 may be present on in a ROIC, e.g., including the indicated system/circuit minus photo-diodes 402(1)-(N), or at a location external to the ROIC, with measurement data provided to the ROIC though an external interface (not shown).

Expected values during operation may be determined by the passive deviation checker 414 with use of the calibration data in the non-volatile memory 416 and expected static current temperature response. The measurement during operation can be performed, e.g., either with a controlled reference background illumination or lack of illumination (e.g., in the dark) or at a known background illumination level. The illumination level may be determined by other measurements of illumination level(s) or set by calibrated illumination sources in the optical system. Deviations from the expected values beyond a programmable threshold may trigger a deviation report delivered through 415 that may, e.g., include a single-bit flag, or additional information including number of photo-detectors deviated, amount of deviation, or other relevant information. The functional safety controller 401 may evaluate these deviation report data and determine if there is a safety impact error that needs to be reported to the application system.

In alternate embodiments (e.g., receiver embodiments), each of the A/P FE circuits 408(1)-(N) can be implemented with or configured to produce an analog output, and the timing conversion block 414 can include or be implemented to contain a digitizer and digital signal processor operative for waveform sampling. In this configuration, each A/P FE 408 can create a continuous output voltage that is representative of the input DC and transient photocurrent from the connected photodiode element 402, respectively. This output voltage can then be digitized within the timing conversion block 412, for example, using an analog-to-digital converter (ADC) (not shown) having a sufficiently high clock speed, e.g., in the GHz or multiple GHz range. Subsequent signal processing of the digitized waveforms can be used to extract pulse timing information as well as static current of the photodiode elements 402(1)-(N). This extracted timing and static information can then passed to the functional safety controller 401 where it can be used to determine fault states within the receiver, e.g., including system/circuit 400.

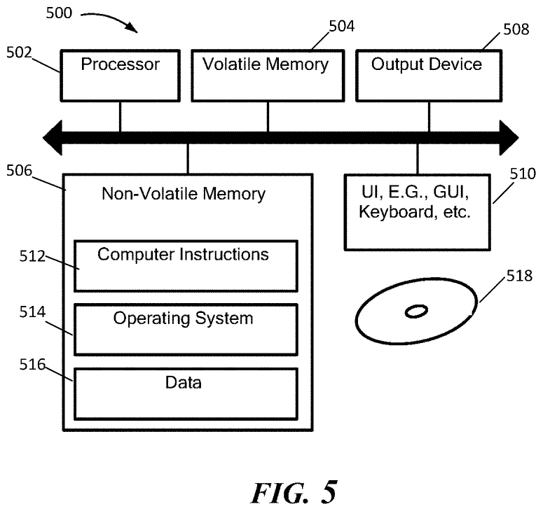

FIG. 5 is a schematic diagram of an example computer system 500 that can perform all or at least a portion of the processing, e.g., steps in the algorithms and methods, described herein. The computer system 500 includes a processor 502, a volatile memory 504, a non-volatile memory 506 (e.g., hard disk), an output device 508 and a user input or interface (UI) 510, e.g., graphical user interface (GUI), a mouse, a keyboard, a display, and/or any common user interface, etc. The non-volatile memory (non-transitory storage medium) 506 stores computer instructions 512 (a.k.a., machine-readable instructions or computer-readable instructions) such as software (computer program product), an operating system 514 and data 516. In one example, the computer instructions 512 are executed by the processor 502 out of (from) volatile memory 504. In one embodiment, an article 518 (e.g., a storage device or medium such as a hard disk, an optical disc, magnetic storage tape, optical storage tape, flash drive, etc.) includes or stores the non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), and optionally at least one input device, and one or more output devices. Program code may be applied to data entered using an input device or input connection (e.g., port or bus) to perform processing and to generate output information.

The system 500 can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. Further, the terms “computer” or “computer system” may include reference to plural like terms, unless expressly stated otherwise.

Processing may be performed by one or more programmable processors executing one or more computer programs to perform the functions of the system. All or part of the system may be implemented as, special purpose logic circuitry, e.g., an FPGA (field programmable gate array) and/or an ASIC (application-specific integrated circuit).

Accordingly, embodiments of the inventive subject matter can afford various benefits relative to prior art techniques. For example, embodiments of the present disclosure can enable or provide lidar systems and components achieving or obtaining an Application Safety Integration Level (ASIL) in accordance with a safety standard such as ISO 26262.

Various embodiments of the concepts, systems, devices, structures, and techniques sought to be protected are described above with reference to the related drawings. Alternative embodiments can be devised without departing from the scope of the concepts, systems, devices, structures, and techniques described. For example, while reference is made above to pulsed lasers, continuous wave (CW) lasers may be used within the scope of the present disclosure. For further example, while reference is made above to use of a laser as an illumination source for a lidar system, in some applications or embodiments an illumination source can include an LED, e.g., a super-luminescent LED, an edge-emitting LED, and/or a surface-emitting LED, etc. Such an LED can include any suitable semiconductor(s) or semiconductor alloy(s) for producing an LED output having desired spectral characteristics (e.g., peak wavelength, linewidth, etc.).

It is noted that various connections and positional relationships (e.g., over, below, adjacent, etc.) may be used to describe elements in the description and drawing. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising, “include,” “includes,” “including,” “has,” “having,” “contains” or “containing,” or any other variation are intended to cover a non-exclusive inclusion. For example, an apparatus, a method, a composition, a mixture, or an article, that includes a list of elements is not necessarily limited to only those elements but can include other elements not expressly listed or inherent to such apparatus, method, composition, mixture, or article.

Additionally, the term “exemplary” means “serving as an example, instance, or illustration. Any embodiment or design described as “exemplary” is not necessarily to be construed as preferred or advantageous over other embodiments or designs. The terms “one or more” and “at least one” indicate any integer number greater than or equal to one, i.e., one, two, three, four, etc. The term “plurality” indicates any integer number greater than one. The term “connection” can include an indirect “connection” and a direct “connection”.

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A pixel current-injection testing system comprising:
a photodetector array having a plurality of photodetectors, each of the photodetectors operative to receive photons as an input and produce as an output a current proportional to the number of received photons per unit time;
a pixel font end circuit including,
(i) a plurality of pixel active/passive (A/P) front end circuits operative to receive the output currents from the plurality of photodetectors and to produce corresponding output signals representative of dark current and/or an arrival time of a photo input to respective ones of the photodetectors of the photodetector array; and
(ii) a pixel front end controller operative to control the plurality of pixel A/P font end circuits for background-current mitigation;
a test current generator operative to produce a test current for one or more of the pixel A/P font end circuits;
a timing conversion circuit operative to receive and evaluate the output signals from the plurality of pixel A/P font end circuits with respect to a timing reference and produce corresponding timing code data as outputs; and
a functional safety controller operative to receive the timing code data from the timing conversion circuit and to produce a functional safety error indicator in the event the timing code data corresponding to the test current is outside of an expected range.

2. The system of claim 1, wherein the plurality of pixel A/P font end circuits includes a test pixel front end circuit that is connected to and configured to receive the test current from the test current generator, and wherein the test current generator is operative to send the test current to the test pixel front end circuit.

3. The system of claim 1, wherein the test current comprises a static current.

4. The system of claim 1, wherein the test current comprises a pulsed current, wherein the functional safety controller is further configured to provide a test trigger to the test current generator to trigger the test current.

5. The system of claim 1, wherein the test current generator is operative to send a test current to the plurality of pixel A/P font end circuits.

6. The system of claim 5, wherein the test current comprises a static current.

7. The system of claim 5, further comprising a pixel and timing controller operative to develop control signals, biases, and references for the pixel front-end circuit, wherein the test current comprises a pulsed current, wherein functional safety controller or pixel and timing controller is configured to receive a system timing reference indicative of timing operation of a lidar illumination source, and wherein the functional safety controller is further configured to provide a test trigger to the test current generator to trigger the test current.

8. The system of claim 1, wherein the test current generator is operative to send a test current to a subset of the plurality of pixel A/P font end circuits.

9. The system of claim 8, wherein the test current comprises a static current.

10. The system of claim 8, wherein the test current comprises a pulsed current, wherein the functional safety controller is further configured to provide a test trigger to the test current generator to trigger the test current.

11. The system of claim 1, wherein the functional safety controller is configured to produce a fault indicator in the event the timing code data associated with the test current is outside of an expected range of values.

12. The system of claim 11, wherein the functional safety controller is further configured to produce an indication of how much the timing code data associated with the test current exceed a threshold value.

13. The system of claim 1, wherein the corresponding output signals produced by the plurality of pixel A/P front end circuits are digital output signals.

14. The system of claim 1, wherein the plurality of A/P front end circuits are configured to produce analog outputs, and wherein the timing conversion circuit includes a digitizer and digital signal processor for extracting pulse timing information and static currents of the plurality of photodetectors.

15. A pixel bias-voltage testing system comprising:
a photodetector array having a plurality of photodetectors, each of the photodetectors operative to receive photons as an input and produce as an output a current proportional to the number of received photons per unit time;
a global bias generation circuit connected to the photodetector array and configured to provide a global bias voltage to the plurality of photodetectors;
a pixel font end circuit including a plurality of pixel active/passive (A/P) font end circuits operative to receive output currents from the plurality of photodetectors and to produce corresponding timing signals as outputs, wherein the pixel font end circuit is further operative to provide a local bias voltage to each of the photodetectors by the respective pixel A/P font end circuit;
a local bias reference circuit connected to the pixel font end circuit and configured to provide an analog reference voltage or analog reference current as a local bias reference to the pixel font end circuit for the producing the local bias voltage;
a timing conversion circuit operative to receive and evaluate the output signals from the plurality of pixel A/P font end circuits with respect to a timing reference and produce corresponding active timing measurements and passive timing measurements as outputs;
a passive deviation checker operative to evaluate differences in passive timing measurements at two or more local bias reference settings and to produce an evaluation as an output; and
a functional safety controller operative to receive the evaluation from the passive deviation checker and to produce a functional safety error indicator in the event the evaluation indicates a passive timing measurement is outside of an expected range.

16. The system of claim 15, wherein the photodetector array comprises photodiodes.

17. The system of claim 16, wherein the photodiodes comprise avalanche photodiodes.

18. The system of claim 15, further comprising non-volatile memory operative to store one or more calibrations of the plurality of photodiodes, wherein the one or more calibrations comprise temperature and/or illumination information, wherein the non-volatile memory is connected to the functional safety controller or the passive deviation checker for determining whether a photodiode operational condition is outside of a value corresponding to the one or more calibrations.

19. The system of claim 18, further comprising a temperature sensor operative to detect temperature and connected to the functional safety controller or the passive deviation checker.

20. The system of claim 15, wherein the passive deviation checker is configured to determine minimum and maximum passive timing measurements for all of the photodetectors.

21. The system of claim 20, wherein the functional safety controller is configured to indicate that at least one photodetector has failed when one or more of the maximum or minimum timing measurements exceed a threshold value.

22. The system of claim 15, wherein the passive deviation checker is configured to determine, for each photodetector, deviations from expected values at each of the two or more local bias reference settings.

23. The system of claim 22, wherein the passive deviation checker is configured to report logical addresses of photodetectors corresponding to a deviation exceeding a predetermined value.

24. The system of claim 15, wherein the corresponding output signals produced by the plurality of pixel A/P front end circuits are digital output signals.

25. The system of claim 15, wherein the plurality of A/P front end circuits are configured to produce analog outputs, and wherein the timing conversion circuit includes a digitizer and digital signal processor for extracting pulse timing information and static currents of the plurality of photodetectors.

26. A pixel current-injection testing circuit comprising:
a pixel font end circuit including,
(i) a plurality of pixel active/passive (A/P) front end circuits operative to receive output currents from a plurality of photodetectors, wherein each of the photodetectors is operative to receive photons as an input and produce as an output a current proportional to the number of received photons per unit time, and to produce corresponding output signals representative of dark current and/or an arrival time of a photo input to respective ones of the photodetectors of the plurality of photodetectors; and
(ii) a pixel front end controller operative to control the plurality of pixel A/P font end circuits for background-current mitigation;
a test current generator operative to produce a test current for one or more of the pixel A/P font end circuits;
a timing conversion circuit operative to receive and evaluate the output signals from the plurality of pixel A/P font end circuits with respect to a timing reference and produce corresponding timing code data as outputs; and
a functional safety controller operative to receive the timing code data from the timing conversion circuit and to produce a functional safety error indicator in the event the timing code data corresponding to the test current is outside of an expected range.

27. The circuit of claim 26, wherein the plurality of pixel A/P font end circuits includes a test pixel front end circuit that is connected to and configured to receive the test current from the test current generator, and wherein the test current generator is operative to send the test current to the test pixel front end circuit.

28. The circuit of claim 26, wherein the test current comprises a static current.

29. The circuit of claim 26, further comprising a pixel and timing controller operative to develop control signals, biases, and references for the pixel front-end circuit, wherein the test current comprises a pulsed current, wherein functional safety controller or pixel and timing controller is configured to receive a system timing reference indicative of timing operation of a lidar illumination source, and wherein the functional safety controller is further configured to provide a test trigger to the test current generator to trigger the test current.

30. The circuit of claim 26, wherein the test current generator is operative to send a test current to the plurality of pixel A/P font end circuits.

31. The circuit of claim 30, wherein the test current comprises a static current.

32. The circuit of claim 30, wherein the test current comprises a pulsed current, wherein the functional safety controller is further configured to provide a test trigger to the test current generator to trigger the test current.

33. The circuit of claim 26, wherein the test current generator is operative to send a test current to a subset of the plurality of pixel A/P font end circuits.

34. The circuit of claim 33, wherein the test current comprises a static current.

35. The circuit of claim 33, wherein the test current comprises a pulsed current, wherein the functional safety controller is further configured to provide a test trigger to the test current generator to trigger the test current.

36. The circuit of claim 26, wherein the functional safety controller is configured to produce a fault indicator in the event the timing code data associated with the test current is outside of an expected range of values.

37. The circuit of claim 36, wherein the functional safety controller is further configured to produce an indication of how much the timing code data associated with the test current exceed a threshold value.

38. The circuit of claim 26, wherein the corresponding output signals produced by the plurality of pixel A/P front end circuits are digital output signals.

39. The circuit of claim 26, wherein the plurality of A/P front end circuits are configured to produce analog outputs, and wherein the timing conversion circuit includes a digitizer and digital signal processor for extracting pulse timing information and static currents of the plurality of photodetectors.

40. A pixel bias-voltage testing circuit comprising:
a global bias generation circuit configured for connection to a photodetector array having a plurality of photodetectors, each of the photodetectors operative to receive photons as an input and produce as an output a current proportional to the number of received photons per unit time, wherein the global bias generation circuit is configured to provide a global bias voltage to the plurality of photodetectors;
a pixel font end circuit including a plurality of pixel active/passive (A/P) font end circuits configured to receive output currents from the plurality of photodetectors and to produce corresponding timing signals as outputs, wherein the pixel font end circuit is further configured to provide a local bias voltage to each of the photodetectors by the respective pixel A/P font end circuit;
a local bias reference circuit connected to the pixel font end circuit and configured to provide an analog reference voltage or analog reference current as a local bias reference to the pixel font end circuit for the producing the local bias voltage;
a timing conversion circuit operative to receive and evaluate the output signals from the plurality of pixel A/P font end circuits with respect to a timing reference and produce corresponding active timing measurements and passive timing measurements as outputs;
a passive deviation checker operative to evaluate differences in passive timing measurements at two or more local bias reference settings and to produce an evaluation as an output; and
a functional safety controller operative to receive the evaluation from the passive deviation checker and to produce a functional safety error indicator in the event the evaluation indicates a passive timing measurement is outside of an expected range.

41. The circuit of claim 40, further comprising non-volatile memory operative to store one or more calibrations of the plurality of photodiodes, wherein the non-volatile memory is connected to the functional safety controller or the passive deviation checker for determining whether a photodiode operational condition is outside of a value corresponding to the one or more calibrations.

42. The circuit of claim 41, further comprising a temperature sensor operative to detect temperature and connected to the functional safety controller or the passive deviation checker.

43. The circuit of claim 40, wherein the passive deviation checker is configured to determine minimum and maximum passive timing measurements for all of the photodetectors.

44. The circuit of claim 43, wherein the functional safety controller is configured to indicate that at least one photodetector has failed when one or more of the maximum or minimum timing measurements exceed a threshold value.

45. The circuit of claim 40, wherein the passive deviation checker is configured to determine, for each photodetector, deviations from expected values at each of the two or more local bias reference settings.

46. The circuit of claim 45, wherein the passive deviation checker is configured to report a logical address of a photodetector corresponding to a deviation exceeding a predetermined value.

47. The circuit of claim 40, wherein the corresponding output signals produced by the plurality of pixel A/P front end circuits are digital output signals.

48. The system of claim 40, wherein the plurality of A/P front end circuits are configured to produce analog outputs, and wherein the timing conversion circuit includes a digitizer and digital signal processor for extracting pulse timing information and static currents of the plurality of photodetectors.
